(19) United States
(12) Patent Application Publication
(10) Pub. No.: US 2002/0107661 A1
(43) Pub. Date: Aug. 8, 2002

(54) System and method for online weight estimation for relocation services

(76) Inventors: John R. Ainlay, Scottsdale, AZ (US); Bryan Schutjer, Paradise Valley, AZ (US); Jeff Sides, Scottsdale, AZ (US); Jodie Galassi, Scottsdale, AZ (US); John Alianello, Scottsdale, AZ (US)

Correspondence Address: LYON & LYON LLP, 633 WEST FIFTH STREET, SUITE 4700, LOS ANGELES, CA, 90071, US

(21) Appl. No.: 09/777,288

(22) Filed: Feb. 5, 2001

(51) Int. Cl. G01G 19/14

(52) U.S. Cl. 702/174; 702/173

(57) ABSTRACT

An estimate of the weight of goods within a household is provided without physical inspection of the household by an estimator, based on certain measurable quantities related to the household. A server transmits to a customer a questionnaire requesting specific data items that are predictive of the weight of goods within the customer's household. The server then receives from the customer a completed questionnaire and utilizes this data to estimate the weight of goods within the customer's household. The server may obtain additional data from a local database or a remote database, and use this additional data in conjunction with the data in the completed questionnaire to estimate the weight of goods within the customer's household.

### BACKGROUND OF THE INVENTION

The field of this invention is relocation services, and more specifically estimation of the weight of household goods to be moved during relocation.

While moving to a new location can be exciting, it is also one of the more stressful experiences faced by a family. Typically, a large number of tasks must be performed to ensure that the move progresses smoothly. One of those tasks involves selecting a relocation services company, or mover. Price is generally an important factor in selecting a mover. Price typically is dependent not only on the distance to be moved, but also on the weight of the goods to be moved. Thus, before a mover can provide a cost estimate for moving household goods, that mover must estimate the weight of those goods. Presently, the mover must send an estimator to the household to inspect it and estimate the volume of goods using well-known rules of thumb. The number of cubic feet of goods is estimated, then converted to weight using an empirically-determined average density of the goods as a conversion factor. This process typically has an accuracy of approximately sixty to seventy percent, plus or minus fifteen percent.

This process is cumbersome and time-consuming for both the mover and the people being moved. Someone is typically present at the household when the estimator arrives, to let the estimator in and answer any questions he or she might have. Since the estimator typically arrives during the business day, one or more members of the household may have to be absent from work when the estimator arrives. Compounding the problem, if two or more movers are to be compared for price, a different estimator typically comes to the household from each mover, requiring a member of the household to be present to receive an estimator on multiple occasions and creating significant inconvenience. From the perspective of the moving company, it is expensive and wasteful to send an estimator to a site to prepare a weight estimate, particularly if the household decides to hire another moving company to move the goods. Thus, there is a need for a simplified weight estimation method that is more convenient for both the members of a household to be moved and the moving companies who provide estimates of moving costs.

### SUMMARY OF THE PREFERRED EMBODIMENTS

An estimate of the weight of goods within a household is provided without physical inspection of the household by an estimator, based on certain measurable quantities related to the household.

In an aspect of a preferred embodiment, a server transmits to a customer a questionnaire requesting specific data items that are predictive of the weight of goods within the customer's household. The server receives from the customer a completed questionnaire and utilizes this data to estimate the weight of goods within the customer's household.

In another aspect of a preferred embodiment, the server may obtain additional data from a local database or a remote database, and use this additional data in conjunction with the data in the completed questionnaire to estimate the weight of goods within the customer's household.

In an alternate embodiment, the server first obtains data predictive of the weight of the goods in a customer's household from a local database, one or more remote databases, or both. A questionnaire is only transmitted to the customer if sufficient data to generate a weight estimate is not obtained from one or more of those databases.

### BRIEF DESCRIPTION OF THE DRAWINGS

FIG. 1 is a schematic representation of a client/server system on which a preferred embodiment is implemented.

FIG. 2 is a flow chart illustrating the method of a preferred embodiment of estimating the weight of a quantity of household goods.

FIG. 3 is a flow chart illustrating the method of an alternate embodiment of estimating the weight of a quantity of household goods.

### DETAILED DESCRIPTION OF THE PREFERRED EMBODIMENTS

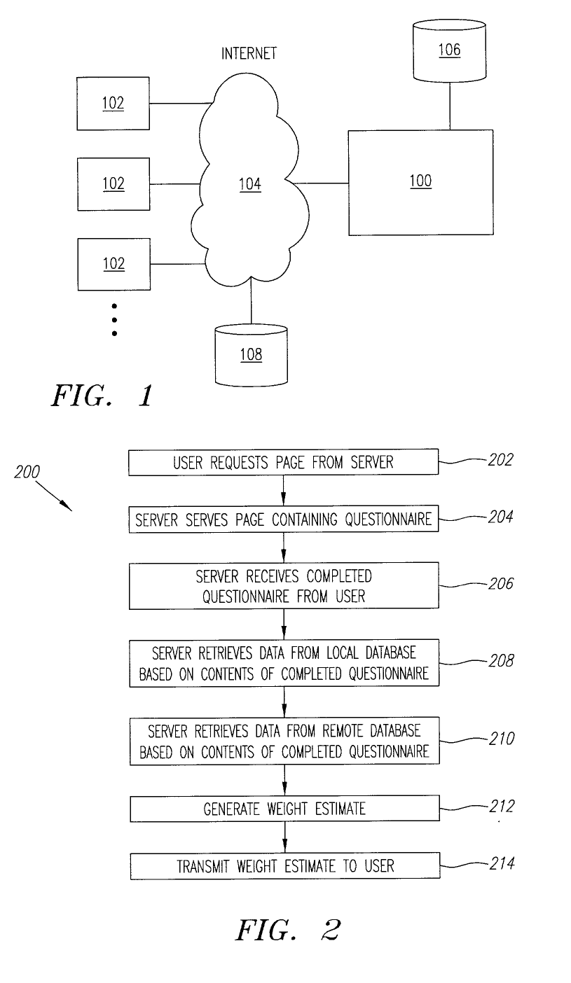

Referring to FIG. 1, a server 100 is connected to one or more clients 102, preferably through a communications network 104 such as the Internet. The clients 102 are information handling systems, each of which may be, by way of example and not limitation, a general-purpose computer, internet appliance, personal digital assistant (PDA), or other information handling system capable of connecting to the server 100, receiving data from the server 100 and transmitting data to the server 100. Different clients 102 may be different types of information handling systems. While three clients 102 are shown in FIG. 1, less than three clients 102 or more than three clients 102 may be connected to the server 100 at the same time. In a preferred embodiment, the connections between each individual client 102 and the server 100 are temporary, and are terminated after communication between each client 102 and the server 100 are completed. The relationship between the server 100 and each client 102 is preferably a standard client/server network relationship, which is well known to those skilled in the art.

The server 100 may be a single information handling system, or may be a plurality of information handling systems connected together. In a preferred embodiment, a firewall (not shown) is preferably provided between the communications network 104 and the server 100, in order to enhance security. The use of a firewall is well known to those skilled in the art. In a preferred embodiment, the server 100 is connected to a local database 106, which is preferably a relational database. The connection between the server 100 and the local database 106 may be persistent or intermittent. The local database 106 is preferably implemented on an information handling system in physical proximity to the server 100. However, the local database 106 may be implemented on the server 100 itself, or may be located away from the server 100. Preferably, the server 100 is also connected to one or more remote databases 108 through the communications network 104. The connection between the server 100 and each remote database 108 may be persistent or intermittent.

Referring to FIG. 2, a preferred embodiment of a method 200 for weight estimation is shown. In a preferred embodiment, the method 200 is implemented over a system as described above. However, other structures, systems or network architectures may be used to implement the method 200 described herein. By utilizing the method 200, the weight of goods in the household can be determined without a physical inspection of the household by an estimator. In step 202, a user of a particular client 102 that wishes to obtain a weight estimate requests a web page from the server 100.

In step 204, the server 100 serves to the client 102 a web page containing a questionnaire. The web page served to the client 102 may be a single page within a web site containing a number of web pages. The term “web site”, as used in this document, refers to the total number of web pages stored on or in association with the server 100 that the server 100 may serve to a client 102. The construction and use of a web site are well known to those skilled in the art. The questionnaire on the web page served to the client 102 requests one or more characteristics of the household for which a weight estimate of goods is desired. As used in this document, the word “household” refers both to a dwelling and the people who live within that dwelling. The dwelling may be a single-family residence, condominium, co-operative, apartment, or other form of real estate in which one or more people reside. The data requested by the questionnaire is selected such that it is predictive of the weight of goods in the household, when taken together or when combined with other data. Thus, the data sought by the questionnaire may encompass the physical or demographic characteristics of the household, or both. By way of example and not limitation, physical characteristics of the household which may be requested in the questionnaire may include square footage, the number of rooms, and the size of the garage. Also by way of example and not limitation, the demographic characteristics of the household may include the number of family members, their ages, and the duration of occupancy of the dwelling. Other questions may be asked as well as or instead of these exemplary questions.

In a preferred embodiment, the questionnaire provides a number of choices for the user to select in response. These choices may be provided as pulldown menus, radio buttons, check boxes or other interfaces by which a user is able to select a particular item from a number of different choices. One or more of the choices offered to the user may be ranges of values. By offering ranges of values to select, data entry errors that may result from typing are eliminated, and choices offered to the user can be preselected to maximize their predictive value as related to estimating the weight of goods within the household. Advantageously, the questionnaire presents these ranges to the user for selection of a single particular range. By way of example and not limitation, to enter the square footage of the household, the user may click on a button provided on the web page, scroll through a list of ranges that is displayed as a result of clicking on the button, then click on the range within which the square footage of the household falls. For example, the particular ranges of square footage as described above may be selected based on empirical data suggesting that households within each range have similar characteristics predictive of the weight of goods within them. However, data may be entered into the questionnaire through one or more boxes or other areas provided on the questionnaire for accepting textual input, if desired. In step 206, the server 100 receives the completed questionnaire from the client 102.

Advantageously, data from sources other than the completed questionnaire is used in addition to the data in the completed questionnaire in order to provide a weight estimate. For example, the web site associated with the server 100 preferably requires a user to register for the weight estimation service. In the course of registration, the user preferably inputs one or more data items regarding his or her household. Such data items required for registration preferably would not appear on the questionnaire, to avoid duplication. These data items, if collected, are stored in the local database 106. Advantageously, the web site associated with the server offers a range of services, and allows a user to create and maintain a profile or record concerning the user's household. This profile or record data, if collected, is stored in the local database 106. The server 100 preferably has a persistent connection to the local database 106. However, the server instead may connect to the local database 106 only as needed to retrieve data from it based on the contents of a completed questionnaire. Optionally, the contents of the completed questionnaire received from the user are written to an appropriate location in the local database 106 upon receipt.

If data items regarding a user are stored in a local database 106, the process optionally continues to step 208, in which the server 100 retrieves data from the local database 106 based on the identity of the user. The identity of the user may be determined from the contents of the completed questionnaire, or from registration information, login information, one or more cookies, or other information or data by which the user made his or her identity known to the server 100. The data retrieved from the local database 106 by the server 100 preferably includes data items, if any, associated with the user that are predictive of the weight of the goods in the user's household. In addition, data may be retrieved from the local database 106 based on the identity of members of the household other than the user, if any. Such members may be listed in the completed questionnaire transmitted to the server 100 from the client 102. Further, data may be retrieved from the local database 106 based on characteristics of the dwelling, such as its address.

Publicly-available data about a household may also be available on at least one remote database 108. The remote database 108 is a database containing publicly-available data, which is connected to the server 100 through a communications network such as the Internet 104. The remote database 108 may be a government database, such as a database including public land and real estate records, or a private database. The server 100 preferably does not have a persistent connection to the remote database 108, and preferably connects to the remote database 108 only as needed to retrieve data from it based on the contents of a completed questionnaire.

If data items regarding a user are stored in a remote database 108, the process optionally continues to step 210, in which the server 100 retrieves data from the remote database 108 based on the identity of the user. The identity of the user may be determined from the contents of the completed questionnaire, or from registration information, login information or other information by which the user made his or her identity known to the server 100. The server 100 may instead, or in addition, retrieve data from a remote database 108 based on other information provided by the user, such as the address of the household. The data retrieved from the remote database 108 by the server preferably includes data items, if any, associated with the user that are predictive of the weight of the goods in the user's household. The server 100 may then retrieve data from one or more additional remote databases 108, if desired. In addition, data may be retrieved from one or more remote databases 108 based on the identity of members of the household other than the user, if any. Such members may be listed in the completed questionnaire transmitted to the server 100 from the client 102. Further, data may be retrieved from one or more remote databases 108 based on one or more characteristics of the dwelling, such as its address.

In step 212, the server 100 uses the data from the completed questionnaire received in step 206, as well as any data optionally retrieved from the local database 106 and/or from at least one remote database 108, to generate an estimate of the weight of the goods in the household. The server 100 preferably applies to that data a statistical model for weight estimation. The statistical model is preferably based on analysis of empirical data. Further, the statistical model is preferably dynamic, meaning that it is subject to change as updated or additional empirical data becomes known. As a product of the statistical model, an estimate of the weight of the goods in the household is generated. Advantageously, the actual weight of the goods in the household is later measured by the mover or other relocation service provider and provided to the server 100 or an entity associated with the server 100. The server 100 can then utilize the actual weight to update the statistical model. In this way, the statistical model can be tested and improved.

In step 214, the server 100 preferably serves a web page to the client 102 with that weight estimate. Alternately, the server 100 may send the client 102 an electronic mail message including the weight estimate, or transmit the weight estimate to the client 102 or user in another manner. In this way, the user obtains a weight estimate without receiving a visit from an employee or agent of a moving company.

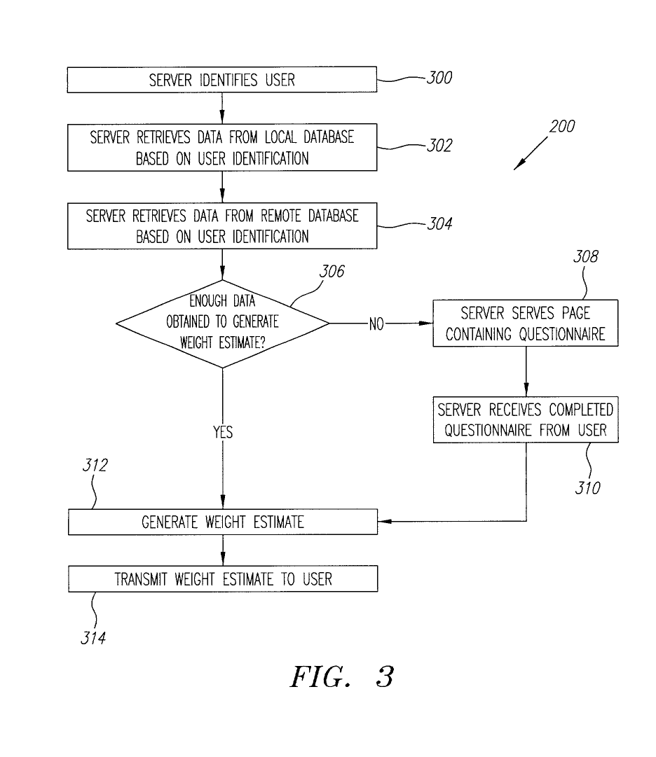

Referring to FIG. 3, an alternate embodiment of the method 200 is shown, in which the questions asked in the questionnaire may be tailored based on other data available about the household. In step 300, the server 100 identifies a user utilizing a client 102 to connect to the server 100. This identification is preferably performed by expressly requiring the user to identify himself or herself, such as by transmitting a username and password to the server 100. However, identification of the user may be performed in other ways, such as but not limited to reading the contents of a cookie resident in the client 102 or identifying the IP address of the client 102.

Next, in step 302, the server 100 retrieves data from the local database 106 based on the identity of the user. The local database 106, and its relationship to the server 100, are preferably as disclosed above with regard to the preferred embodiment. The data retrieved from the local database 106 by the server 100 preferably includes data items, if any, associated with the user that are predictive of the weight of the goods in the user's household. Next, in step 304, the server 100 retrieves data from one or more remote databases 108 based on the identity of the user. The remote database 108, and its relationship to the server 100, are preferably as disclosed above with regard to the preferred embodiment. The data retrieved from the remote database 108 by the server 100 preferably includes data items, if any, associated with the user that are predictive of the weight of the goods in the user's household.

In step 306, the server 100 determines whether enough data has been obtained in steps 302 and 304 to enable a weight estimate to be generated. Preferably, the server 100 compares the types of the data items obtained in steps 302 and 304 to a stored list of the minimum types of data records needed to generate a weight estimate. However, other methods may be used to determine whether enough data has been obtained. If enough data has been obtained, the process moves to step 312, where a weight estimate is generated as described above in regard to the preferred embodiment. Next, in step 314 that weight estimate is transmitted to the user, also as described above in regard to the preferred embodiment.

If in step 306 enough data was not obtained in steps 302 and 304 to allow a weight estimate to be generated, the process proceeds to step 308. In step 308, the server 100 serves to the client 102 a page having a questionnaire. The questionnaire is preferably tailored to request data items that have not previously been obtained in steps 302 and 304. By way of example and not limitation, if the number of bedrooms in the household is obtained from the local database in step 302, then the questionnaire does not include a request for the number of bedrooms in the household. By tailoring the questionnaire to request only the required data that is not already available to the server 100, convenience to the user and simplicity of use are enhanced. Next, in step 310, the server receives the completed questionnaire from the client 102, as described above in regard to the preferred embodiment. A weight estimate is then generated in step 312 and transmitted to the user in step 314.

In this alternate embodiment, either step 302 or step 304 may be omitted, if enough weight-predictive data can be retrieved in the other step to allow a weight estimate to be generated in step 312. In this way, the method 200 is rendered even more efficient, minimizing the number of steps and thus the time required to generate a weight estimate.

While a preferred method of weight estimation has been disclosed above using a computer interface, the invention is not limited to network-based communications between a customer and the provider of weight estimates. If desired, the customer may fill out a questionnaire by hand and transmit that survey to the provider of weight estimates by mail, facsimile, overnight courier or other means. The provider may then enter that weight into the server 100, obtain a weight estimate, and provide that weight estimate to the customer by mail or other means. Thus, the benefits of the invention are not restricted to those households having access to a communications network 104 such as the Internet.

A preferred method for online weight estimation for relocation services and many of its attendant advantages has thus been disclosed. It will be apparent, however, that various changes may be made in the content and arrangement of the steps of the method without departing from the spirit and scope of the invention, the method hereinbefore described being merely preferred or exemplary embodiments thereof. Therefore, the invention is not to be restricted or limited except in accordance with the following claims and their legal equivalents.

What is claimed is:

1. A method for estimating the weight of goods in a household without physical inspection of the household by an estimator, comprising:
receiving one or more first data items predictive of the weight of the goods in the household; and
generating a weight estimate for the goods within the household based on said first data items.

2. The method of claim 1, further comprising transmitting a questionnaire to the household that requests said first data items.

3. The method of claim 2, wherein said questionnaire is transmitted electronically to the household over a communications network.

4. The method of claim 1, further comprising connecting to a local database and retrieving one or more second data items predictive of the weight of the goods in the household based on one or more of said first data items, wherein said weight estimate is additionally based on said one or more second data items.

5. The method of claim 1, further comprising connecting to a remote database and retrieving one or more third data items predictive of the weight of the goods in the household based on said one or more first data items, wherein said weight estimate is additionally based on said one or more third data items.

6. The method of claim 5, wherein said remote database contains publicly-available information about the household.

7. The method of claim 1, wherein said first data items are received electronically from the household over a communications network.

8. The method of claim 1, wherein said generating step comprises applying a statistical model to said first data items.

9. The method of claim 8, further comprising:
receiving a measured weight of the goods; and
updating said statistical model based on said measured weight.

10. The method of claim 1, further comprising:
determining whether said first data items are sufficient to generate a weight estimate;
tailoring a questionnaire to request one or more second data items predictive of the weight of the goods in the household, if said first data items are insufficient to generate a weight estimate;
transmitting said questionnaire to the household; and
receiving said one or more second data items.

11. A method of obtaining from a server an estimate of the weight of goods within a household, wherein the server receives one or more first data items about the household, connects to a local database, retrieves one or more second data items based on the one or more first data items, and generates a weight estimate for the goods within the household based on said first data items and said second data items, comprising:
requesting from a server a page including a questionnaire adapted to elicit the one or more first data items;
completing said questionnaire by providing said one or more data items; and
transmitting said completed questionnaire to the server.
